(19) United States
(12) Patent Application Publication
(10) Pub. No.: US 2023/0080913 A1
(43) Pub. Date: Mar. 16, 2023

(54) ELECTROCATALYSTS DOPED WITH CATALYTIC ACTIVITY NANOPARTICLES

(71) Applicant: Hydrolyst LLC, Rapid City, SD (US)

(72) Inventors: Kelsey Fitzgerald, Rapid City, SD (US); Kirstie Gildemeister, Rapid City, SD (US)

(73) Assignee: Hydrolyst LLC, Rapid City, SD (US)

(21) Appl. No.: 17/942,810

(22) Filed: Sep. 12, 2022

Related U.S. Application Data
(60) Provisional application No. 63/243,328, filed on Sep. 13, 2021.

(51) Int. Cl. B01J 37/34; B01J 37/02; B01J 35/00; B01J 21/06; B01J 21/18; B01J 35/10

(52) U.S. Cl. CPC B01J 37/348; B01J 37/0234; B01J 35/0033; B01J 21/063; B01J 21/18; B01J 35/10; B01J 37/349

(57) ABSTRACT

The PEO grown metal-oxide coated electrocatalyst replaces the current carbon supported catalyst with a more robust and effective metal-oxide scaffold, which increases the lifetime and efficiency of fuel cells and electrolyzers. Using a novel method in catalyst ion and nanoparticle application to the electrocatalyst scaffold, we can increase the lifetime by reducing particle dissolution, resulting in longer acceptable efficiencies. The process also has lower infrastructure and upkeep costs to those currently employed, so savings can be passed on to the consumer.

### CROSS-REFERENCE TO RELATED APPLICATIONS

This application claims priority under 35 U.S.C. § 119 to provisional application Ser. No. 63/243,328 filed Sep. 13, 2021, which is incorporated by reference in its entirety.

### BACKGROUND

### I. Field of the Disclosure

The present disclosure relates to metal-oxide electrocatalysts. Particularly, but not exclusively, the present disclosure relates to electrocatalysts having a metal-oxide scaffold, doped with high catalytic activity nanoparticles produced using plasma electrolytic oxidation.

### II. Description of the Prior Art

Commercial electrocatalysts typically use platinum group metal (PGM) nanoparticles dispersed on a carbon support. Catalysts are expensive to produce and degrade quickly leading to rapid decline in efficiency as the loss of PGM nanoparticles increases. The loss in efficiency is compounded as degradation of the carbon support also contaminates the proton exchange membrane (PEM) system. Therefore, mechanically robust catalysts with comparable reaction kinetics are needed.

### SUMMARY

Therefore, it is a primary object, feature, or advantage of the present disclosure to improve over the state of the art.

According to at least one exemplary aspect, a metal-oxide electrocatalyst producing system for creating a catalytically active metal-oxide layer on a metal substrate is disclosed. The system includes a tank housing an electrolyte bath, wherein the electrolyte bath contains a plurality of metal ions. The system may further include a power supply operatively connected to the electrolyte bath, the power supply has a positive output and a negative output. The system may also have an anode connected to the positive output and a metal substrate, wherein the anode supplies an anode voltage from the power supply to the metal substrate when the metal substrate is submerged in the electrolyte bath. A cathode may be connected to the negative output and partially submerged in the electrolyte bath. The electrolyte bath produces an oxide layer that grows on a surface of the metal substrate.

In another exemplary aspect of the present disclosure a plasma electrolytic oxidation system for producing metal-oxide electrocatalysts is disclosed. The system may include a tank housing an electrolyte bath, wherein the electrolyte bath contains a plurality of nanoparticles and a power supply operatively connected to the electrolyte bath, the power supply has both a positive output and a negative output. The system may further include an anode connected to the positive output and a substrate, wherein the anode conducts a high voltage received from the power supply to the substrate when the substrate is submerged in the electrolyte bath and a cathode connected to the negative output and partially submerged in the electrolyte bath. The system may also include a substrate, wherein a metal-oxide layer forms on a surface of the substrate when the voltage circuit is completed and the nanoparticles in the electrolyte are encapsulated by the metal oxide layer forming on the metal substrate producing an electrocatalyst.

In another exemplary aspect of the present disclosure a method for producing metal-oxide is disclosed. The method may include providing an electrolyte bath housed in a tank, wherein the electrolyte bath includes at least one metal ion and an alkaline solution. The method further includes connecting a cathode to a power supply and partially submerging the cathode in the electrolyte bath and connecting an anode to a power supply and a substrate holder, wherein the substrate holder holds a metal substrate. The method may further include supplying a voltage to the anode from the power supply to the metal substrate, wherein the cathode completes the circuit when the metal substrate is submerged in the electrolyte bath and rolling or coiling the metal substrate from the metal substrate holder to a metal-oxide electrocatalyst holder, where the metal substrate is partially submerged in the electrolyte bath. The method may also include growing a metal-oxide layer on a surface of the metal substrate when the metal substrate is submerged in the electrolyte bath transforming the metal substrate into a metal-oxide electrocatalyst and wherein the metal-oxide layer may include the at least one metal ion and removing the metal-oxide electrocatalyst from the electrolyte bath by the metal-oxide electrocatalyst holder.

In another exemplary aspect of the present disclosure, a coated metal oxide electrocatalyst material is disclosed. The coated metal oxide electrocatalyst material may include a substrate and a functional material, which may include a catalyst, forms on a surface of the substrate. The substrate may be submerged in an electrolyte bath transforming the substrate into an electrocatalyst and wherein an oxide layer includes at least one nanoparticle from the electrolyte bath. An anode connected to a positive output and the substrate supplies an anode voltage to the substrate when the metal substrate is submerged in the electrolyte bath; and a cathode connected to a negative output and partially submerged in the electrolyte bath, wherein the anode and the cathode complete a voltage circuit.

One or more of these and/or other objects, features, or advantages of the present disclosure will become apparent from the specification and claims that follow. No single aspect need provide every object, feature, or advantage. Different aspects may have different objects, features, or advantages. Therefore, the present disclosure is not to be limited to or by any objects, features, or advantages stated herein.

### BRIEF DESCRIPTION OF THE DRAWINGS

Illustrated aspects of the disclosure are described in detail below with reference to the attached drawing figures, which are incorporated by reference herein, and where:

FIG. 1 shows a lab scale plasma electrolytic oxidation (PEO) process schematic.

FIG. 2 shows continuous PEO process schematic.

FIG. 3 shows continuous PEO mandrel connections.

FIG. 4 illustrates the main components of a typical proton exchange membrane fuel cell (PEMFC) stack.

FIGS. 5A-5B provide images of Ti mesh attached to anode rod before PEO (FIG. 5A) and after PEO (FIG. 5B).

FIG. 6A-6C provide images of a scanning electron microscope (SEM) (FIG. 6A) and Energy-Dispersive X-Ray Spectroscopy (EDS) (FIG. 6B) along with an analysis (FIG. 6C) of PEO electrocatalyst grown at 400 V for 75 minutes.

FIGS. 7A-7C provide SEM images showing the mesh size analysis of as-is Ti mesh (FIG. 7A), PEO at 375 V for 75 minutes (FIG. 7B), and PEO at 400 V for 75 minutes (FIG. 7C).

FIG. 8 provides SEM image with pore size analysis of smaller pores found on the surface of sample MOC-9.

FIG. 9 provides SEM image with pore size analysis of larger pores found on the surface of sample MOC-9.

### BRIEF DESCRIPTION OF THE TABLES

Illustrated aspects of the disclosure are described in detail below with reference to the attached Tables, which are incorporated by reference herein, and where:

Table 1 provides a comprehensive composition of the electrolyte bath for preliminary tests.

### DETAILED DESCRIPTION

This disclosure provides a method and system for producing metal-oxide electrocatalysts for use in hydrogen fuel cells and electrolyzers. The process uses plasma electrolytic oxidation (PEO) which is currently not employed for electrocatalyst production. The method and system may include a proton exchange membrane (PEM) system due to the PEM system's versatility, and compatibility with solar and wind energy sources. PEM systems show great promise for efficient energy production and there have been recent improvements to make it more commercially available. Unfortunately, they are still not economically feasible due to high manufacturing costs and poor mechanical properties of current commercial electrocatalysts. The disclosed metal-oxide electrocatalyst production method and system considerably minimizes current issues with these electrocatalysts.

### 1. Metal-Oxide Electrocatalyst Production

Plasma electrolytic oxidation (PEO) is a technology that uses high voltage (100-500 V) to grow a functional material such as metal oxide layer on a metal substrate while submerged in an electrolyte bath. The metal-oxide layer may act as an electrocatalyst. The PEO process is less environmentally caustic and may use an alkaline solution for the electrolyte bath. The alkaline solution may be mild or have a low concentration. The alkaline solution may contain sodium, potassium, phosphates, silicates or carbonates as well as a wetting agent such as a surfactant or detergent.

Most importantly, the PEO process provides the benefits of high corrosion, erosion, and wear resistance, and allows the operator to add metal ions into the scaffold and embed nanoparticles and microparticles in coatings while also controlling porosity and thickness. The PEO process produces non-toxic byproducts that are free of ammonia, acids, heavy metals, or chromium. The metal-oxide coated electrocatalyst production process uses metal salt molecules that contain catalytically active metal ions to build the electrolyte bath. This ensures that the metal oxide scaffold contains the desired metal ions.

The metal ions used may include alkali metals (lithium (Li), sodium (Na), potassium (K), rubidium (Rb), cesium (Cs), and francium (Fr)), alkaline earth metals (beryllium (Be), magnesium (Mg), calcium (Ca), strontium (Sr), barium (Ba), and radium (Ra)) or transition metals. The transition metals may include scandium (Sc), titanium (Ti),vanadium (V), chromium (Cr), manganese (Mn), iron (Fe), cobalt (Co), nickel (Ni), copper (Cu), zinc (Zn), yttrium (Y), zirconium (Zr), niobium (Nb), Molybedum (Mo), technetium (Tc), ruthenium (Ru), rhodium (Rh), palladium (Pd), silver (Ag), cadmium (Cd), hafnium (Hf), tantalum (Ta), tungsten (W), rhenium (Re), osmium (Os), iridium (Ir), platinum (Pt), gold (Au), mercury (Hg). The transition metals may also include lanthanum (La), actinium/actinide (Ac), rutherfordium (Rf), dubnium (Db), seaborgium (Sg), bohrium (Bh), Molybdenum hassium (Hs), meitnerium (Mt), darmstadtium (Ds), roentgenium (Rg) or copernicium (Cn). The metal ions may also include post-transition metals aluminum (Al), gallium (Ga), Indium (In), Tin (Sn), Thallium (Tl), lead (Pb), Bismuth (Bi), Polonium (Po). In other aspects the metal ions may include at least one metalloid comprising boron (B), silicon (Si), germanium (Ge), arsenic (As), antimony (Sb), tellurium (Te), astatine (At).

In some aspects the molecular additions may include PtBr₂, PtCl₂, PtCl₄, Pt(NH₃)₂Cl₄, Pt(NH₃)₂Cl₂, H₂Pt(OH)₆, PdBr₂, PdCl₂, PdSO₄, Pd(NO₃)₂, Pd(NH₃)₄Br₂, [Ru(NH₃)₆]Cl₂, [Ru(NH₃)₆]Cl₃, RuCl₃, Rh₂(OOCCH₃)₄, RhCl₃, Rh(NO₃)₃, Rh₃(SO₄)₃, IrCl₃, IRCl₄, Ir₄(CO)₁₂, OsCl₃, Ag₂CO₃, AgClO₃, AgCl, AgNO₃, AgNO₂, AgReO₄, Ag₂SO₄, Ag₂O₄S, AuCl, AuCl₃, Au(OH)₃, KAuCl₄, FeBr₂, FeCl₂, FeCl₃, MnBr₂, MnCl₂, KMnO₄, Mn₂O₃, VCl₂, CoBr₂, COCl₂, Co(OH)₂, NiBr₂, NiCl₂, Ni(OH)₂, MgBr₂, MgCl₂, MgO, Mg₂SiO₄, ZnBr₂, ZnCl₂, ZnMoO₄, CuBr, CuBr₂, CuCl, CuCl₂, WCl₄, WCl₆, MoCl₅, ZrCl₄, Zr(OH)₄.

The metal oxide coated electrocatalyst system may also use nanoparticles and microparticles of catalytically active elements in the electrolyte for the purpose of embedding these particles in the scaffold. These nanoparticle and microparticle additions may include at least one of Pt, Pd, Ru, Rh, Ir, Os, Ag, Au, Fe, Co, Ni, Cu, W, Mn, Mg, Mo, C, V, Zn, Zr. In some aspects, it is critical that catalyst nanoparticles are well dispersed in the electrolyte bath to ensure that they are uniformly distributed in the resulting metal oxide support. Surfactants and dispersants may be employed to ensure dispersion in the electrolyte solution while accounting for solution ionic strength. The surfactants and dispersants may include 2,2-Dimethoxy-2-phenyl-acetophenone, Poly(acrylic acid), Hexadecyl trimethyl ammonium bromide, tetraoctylammonium bromide, glycerin, ethyl alcohol, or any other surfactant or dispersant that ensures dispersion of the nanoparticles in the electrolyte solution. An emphasis may be placed on maintaining dispersion via steric and electrostatic stabilization throughout dynamic ionic strength conditions during the PEO process with the use of ionic surfactants and polymeric additives. These colloidal dispersion strategies have been studied in particle size regimes ranging from quantum dots to microscale particles, and have well defined boundaries for successful stabilization based on the Derjaguin, Landau, Verwey, and Overbeek (DLVO) theory and Hansen Solubility Parameters.

In at least one aspect, a specific electroconductivity (EC) and pH needs to be maintained to optimize the coating. The metal-oxide electrocatalyst system's process can operate at 7-14-H and 0.5 μS/cm-20 μS/cm. In one aspect of the present disclosure, the metal oxide coated electrocatalyst system operates at 11-14 pH and 12.5 μS/cm-13.5 μS/cm EC. To fix these parameters a combination of the metal salts listed above and the additions of some molecules that are more typical in PEO electrolytes are used. These electrolyte additions can include electrolytes such as alkali metals, post-transition metals, metalloids, or reactive nonmetals. For example, the electrolyte additions may include, at least one of: KOH, Na₃PO₄, Na₂SiO₃, NaOH, NaAlO₂, K4P₂O₇.

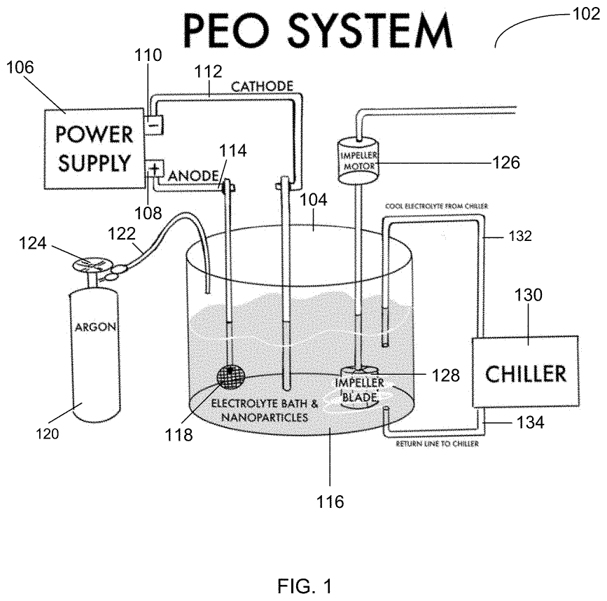

In addition to the electrolyte addition, the metal-oxide electrocatalyst system may use a semi-continuous or continuous PEO process that replaces the current batch processing techniques. The continuous process uses a roll-to-roll method adapted for the complexities of the PEO process. A drawn schematic of one exemplary batch PEO process is shown in FIG. 1. In some aspects of the PEO system 102, the PEO can take place in a tank 104 or a localized processing fixture. The PEO system 102 may include a power supply 106 having a positive output 108 and a negative output 110. The power supply 106 may be a power inverter such as a Micro-arc Oxidation (MAO)/Plasma Electrolytic Oxidation (PEO) Power Inverter where frequencies, positive and negative voltages, as well as pulse widths can be adjusted individually. The power supply 106 may be a computerized power supply, a pulsed power supply, a DC power supply, or an AC power supply or any other type of power supply that is sufficient to power the PEO system 102. A cathode 112 may be connected to the negative output 110 of the power supply 106 and an anode 114 may be connected to the positive output 108 of the power supply. The cathode 112 and the anode 114 may be partially submerged into the tank 104. The tank 104 may house an electrolyte bath 116. The electrolyte bath 116 may have additional nanoparticles. A substrate 118 may be connected to the anode 114 and submerged in the electrolyte bath 116. During the PEO process the substrate 118 may be coated with electrocatalysts produced by the PEO system 102. During the production of the electrocatalyst, concentrated hydrogen may be produced. Inert gas housed in a gas container 120 or gas tank 120 may be introduced into the tank 104 through a tube 122 or pipe 122 to dilute the hydrogen. In one aspect, the gas used to dilute the concentrated hydrogen may be argon. A valve 124 may control the release of the inert gas from the gas tank 120. A motor 126 may be attached to a mixer 128. The motor 126 may be an impeller motor and the mixer 128 may be a rotating impeller blade. The motor 126 may rotate the mixer 128 to stir the electrolyte bath 116 to ensure complete mixing of the electrolyte during the PEO process. A chiller 130 may be connected to the tank to cool the PEO system 102 and recycle the electrolyte. The chiller 130 may also filter the electrolyte. A feed tube 132 connected to the chiller 130 may introduce cooled electrolyte from the chiller 130 into the tank 104. A return tube 134 may recycle electrolytes from the tank 104 to the chiller 130.

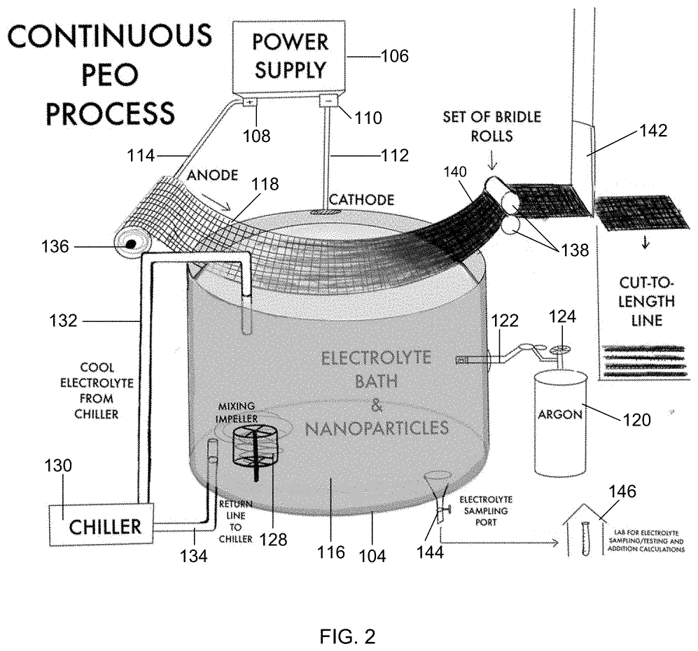

An exemplary continuous PEO process using the PEO system 102 is shown by the drawn schematic in FIG. 2. In at least one aspect, the continuous process may use a substrate holder 136 such as a mandrel, roller, arbor, or a substrate feeder to hold a large roll of the substrate 118. The substrate may be a mesh or sheet roll of any PEO compatible “valve metal”, “precious metal” or “coinage metal” including, for example, Al, Ti, Mg, Ag, Au, Pt, Pd, Ir, Rh, Ru, Rd, Os, Ni, or any other suitable value metals, precious metals, or coinage metals. In one aspect, the metal-oxide electrocatalyst system may use Ti and Al substrates for electrocatalyst synthesis. The anode 114 from the power supply 106 may be connected to the metal mandrel 136 to deliver the anode voltage to the substrate 118 that is submerged in the electrolyte bath 116. The mandrel 136 may be rotated by a motor, such as a stepper motor, to allow fine control process speeds. To protect the mandrel motor from the high voltages of the power supply, an insulator standoff may be used to attach the motor shaft to the mandrel shaft. The PEO system 102 may include a power supply 106 having a positive output 108 and a negative output 110. A cathode 112 may be connected to the negative output 110 of the power supply 106. During the production of the electrocatalyst, concentrated hydrogen may be produced. Inert gas housed in a gas container 120 or gas tank 120 may be introduced into the tank 104 through a tube 122 or pipe 122 to dilute the hydrogen. In one aspect, the gas used to dilute the concentrated hydrogen may be argon. A valve 124 may control the release of the inert gas from the gas tank 120. A chiller 130 may be connected to the tank to cool the PEO system 102 and recycle the electrolyte. The chiller 130 may also filter the electrolyte. A feed tube 132 connected to the chiller 130 may introduce cooled electrolyte from the chiller 130 into the tank 104. A return tube 134 may recycle electrolytes from the tank 104 to the chiller 130.

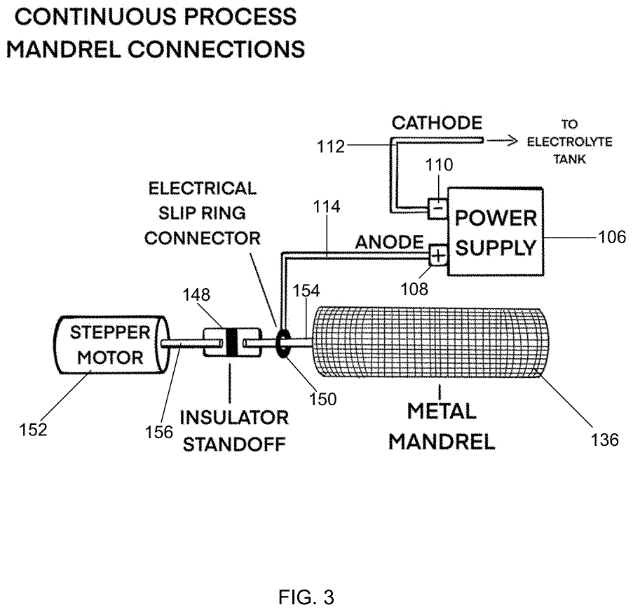

In at least one aspect, a metal-oxide electrocatalyst holder 138 may hold the metal-oxide electrocatalyst 140 as it leaves the tank 104. The metal-oxide electrocatalyst substrate holder may be a set of bridle rolls, a mandrel or any other holder or type of roller capable of holding the metal-oxide electrocatalyst as it is removed from the bath. In one aspect of the present disclosure, a set of rubber bridle rolls 138 may be located at the exit end of the line. The bridle rolls 138 may also be operated by a stepper motor 152 (shown in FIG. 3) that matches the speed of the mandrel motor to maintain the proper tension. This may control the length of substrate submerged in the electrolyte. The speed of the stepper motors may determine the residence time of the process which can be controlled to manipulate coating thickness. An exemplary continuous process also features a sampling port 144 in the tank that allows for safe and continuous sampling to monitor and maintain EC, pH, and elemental composition by using laboratory testing feedback. In some aspects, after leaving the metal-oxide electrocatalyst holder 138, the metal-oxide electrocatalyst 140 is cut by a cutter 142. The metal-oxide electrocatalyst 140 may be a cut-to-length line.

FIG. 3 is a drawing that illustrates the location of the insulator standoff 148 as well as the slip ring electrical connector 150 that allows the power supply to maintain and electrical connection as the mandrel spins 136. A first connector 154 may connect the substrate holder/mandrel 136 to the insulator standoff 148. A second connector 156 may connect the stepper motor 152 to the insulator standoff 148. The tank that contains the electrolyte may be connected to the cathode 112 from the power supply 106. The tank may be made of stainless steel. The PEO system 102 may be lab scale. Initial results showed successful encapsulation of transition metal particles from the electrolyte bath in one exemplary aspect.

### 1.2 Benefits of the Metal Oxide Coated Electrocatalyst System

Current PEM electrocatalysts use platinum nanoparticles dispersed on a carbon support (Pt/C). Over time and increased usage, carbon supports corrode and release residual platinum and carbon into the PEM system. As corrosion progresses, PEM efficiency is reduced and the electrocatalyst requires replacement. The maintenance and materials required to replace electrocatalysts and maintain high efficiency can become costly and present a barrier to PEM adoption. The metal oxide coated electrocatalyst system produces chemically and mechanically robust supports created through PEO technology. PEO allows the metal oxide coated electrocatalyst system to produce a corrosion resistant metal oxide support grown on a highly conductive metal substrate and doped with carbon and transition metal nanoparticles at catalytically active interface sites to optimize catalytic potential.

### 2.3 Current Research

Research has been performed to identify non-carbon materials to replace Pt/C electrocatalysts. Oxides, carbides, and nitrides of metals such as Ti, W, and Mo exhibit promising corrosion resistance and improved stability in fuel cell conditions. However, most of these non-carbon materials suffer from low conductivities and/or poor platinum dispersion, thus limiting efficiency of the fuel cell. The PEO process offers an opportunity to grow composite coatings on light-metal mesh substrates by loading the electrolyte bath with transition metal and carbon nanoparticles. Current metal oxide supports lack conductivity, catalytic potential, and have less chemical and mechanical stability than PEO grown supports. The metal oxide coated electrocatalyst system and method produces an electrocatalyst that improves all the downfalls of both carbon supported and current metal oxide supported electrocatalysts. In the metal oxide coated electrocatalyst system, electrocatalysts have improved catalytic potential due to controlled porosity and nanoparticle distribution as well as better chemical and mechanical stability due the inherent structure and properties of PEO, which encapsulates the catalyst nanoparticles in the support with micro-arcs instead of the less durable deposition/coating methods currently used.

1.3.1 The Metal Oxide Coated Electrocatalyst system Decreases Catalyst Nanoparticle Dissolution

Nanoparticle dissolution is the main problem that plagues current PEM electrocatalysts. This particle dissolution is decreased remarkably in the PEO scaffold when compared to other metal oxide and carbon supports. The current electrocatalyst systems deposit catalytic particles on a scaffold using a coating technique. As the coating is exposed to the aqueous environment of PEM electrolysis it wears and degrades which discharges the catalyst nanoparticles into the system where they are no longer effective. The metal oxide coated electrocatalyst system's electrocatalyst is different in that it is not considered a coating technique but is instead referred to as a conversion technique because it grows a metal oxide into the surface of a metal substrate. The converted metal oxide surface has excellent adhesion to the parent metal because the first layer grows into the metal core. PEO grows this metal oxide scaffold by creating micro-arcs which produce molten metal that is quenched by the surrounding electrolyte. When the molten metal is quenched, it encapsulates local nanoparticles by micro-welding them into the structure. The metal oxide coated electrocatalyst system's electrocatalysts have superior mechanical and chemical stability because the catalytically active nanoparticles are encapsulated by micro-welds.

As mentioned above, the metal oxide coated electrocatalyst system production process creates a porous metal oxide support on a conductive metal core, embedded with multi-component catalysts, preventing nanoparticle dissolution while improving catalyst stability and activity. Multi-component catalysts use three or more transition metals creating a composite with mismatched lattices that induces strain and shifts the d-band center. This lowers the adsorption energy of surface oxygenated intermediates and enhances catalytic surface activity. These PEO-grown, metal oxide supports promise to greatly improve current carbon and metal oxide supports by encapsulating catalytically active nanoparticles into the support and decreasing particle dissolution by taking advantage of inherent corrosion and wear resistance of PEO coatings.

### 1.3.2 Summary of PEM System

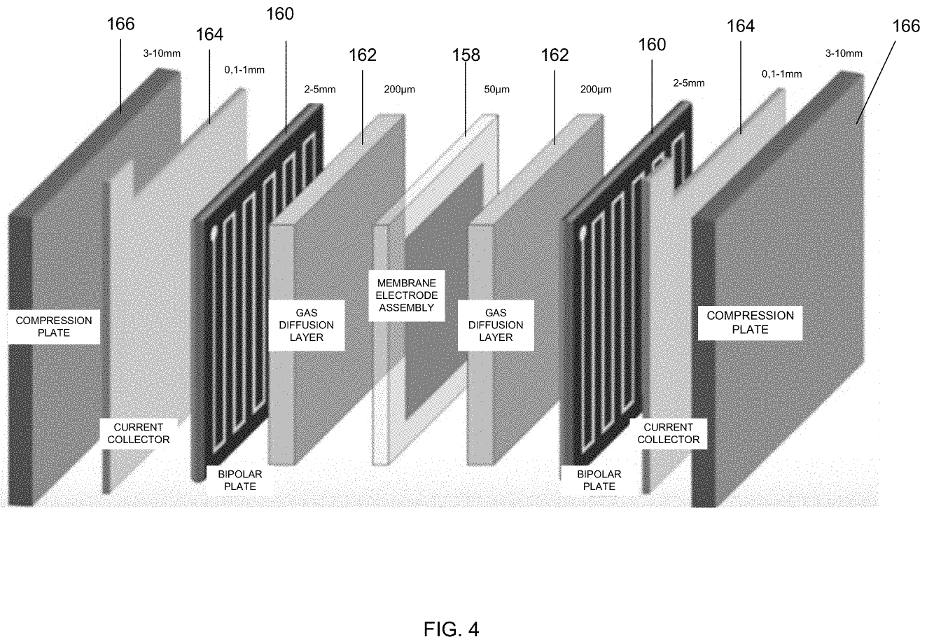

FIG. 4 illustrates components of a typical proton exchange membrane fuel cell (PEMFC) single stack. At the center of the stack is the membrane electrode assembly 158 that contains the electrocatalyst, which is the component that the metal oxide coated electrocatalyst system produces. The membrane electrode assembly may be 50 μm in width. In a fuel cell, hydrogen and air are introduced from opposite ends of the stack. The gasses flow through the bipolar plate 160 channels and then through gas diffusion layers 162 where they contact opposite sides of the membrane electrode assembly (MEA). The gas diffusion layers may be 200 μm in width. The bipolar plates 160 may be 0.1-1 mm in width. The MEA can include the proton exchange membrane (PEM) sandwiched between cathode and anode electrocatalysts. One side of the MEA splits water to oxygen and hydrogen. Equation 1 shows the direct, 4-electron reaction.

2H₂O→O₂+4H⁺+4e⁻ Equation 1

This is the preferred reaction due to the 4-electron yield. Equation 2 and Equation 3 show the undesirable reaction which produces hydrogen peroxide and only yields 2 electrons.

O₂+H₂O+2e⁻→HO₂⁻+OH⁻ Equation 2

HO₂⁻+H₂O+2e⁻→3OH⁻ Equation 3

Electrons cannot pass through the PEM, so they migrate to the current collectors 164, such as to the anode current collector, which forms a circuit that powers the electrical load. The electrons complete the circuit to the cathode current collector and contact the cathode electrocatalyst as hydrogen atoms migrate through the PEM to the cathode catalyst. A compression plate 166 may be adjacent to each of the current collectors 164. Hydrogen atoms, electrons, and oxygen from air may all meet at the cathode catalyst and form water.

The PEM electrolyzer may be similar except that water is input on the anode side of the stack where it contacts the anode catalyst and separates H₂O molecules into hydrogen, oxygen, and electrons. Hydrogen atoms migrate through the PEM to contact the cathode catalyst while electrons move through the current collector circuit and contact the cathode catalyst, forming H₂ that is collected and stored for later use in a PEMFC. Equation 4 shows this hydrogen reaction.

4H⁺+4e⁻→2H₂ Equation 4

Oxygen can be collected from the anode side of the stack and stored for other uses.

### 1.3.3 PEO Process

PEO is a process that delivers high voltage (100-500 volts) and current (5-30 amperes) to a metal substrate that is submerged in a non-hazardous electrolyte solution. High current and voltage create a plasma at the surface of the substrate which then forms a porous metal oxide layer. The growth mechanism of the PEO process generates inherently strong adhesion making

PEO favorable in comparison to sol-gel and plasma spray techniques. Chemistry of metal oxide formation is dependent on the substrate metal. Equation 5 and Equation 6 show anode reactions that occur at the surface of a titanium substrate forming titanium dioxide. Equation 7 shows the anode reaction that occurs at the surface of an aluminum substrate forming aluminum oxide.

Ti→Ti⁴⁺+4e⁻ Equation 5

Ti⁴⁺+2O²⁻→TiO₂ Equation 6

2Al+3O²⁻→Al₂O₃+6e⁻ Equation 7

The PEO process also leads to thermal decomposition of water shown in Equation 8 and Equation 9, as well as hydrogen evolution shown in Equation 10. This hydrogen evolution can present a safety concern, so to prevent any issues the hydrogen is diluted with argon to mitigate risks associated with concentrated hydrogen.

2H₂O+2e^{-→H}₂+2OH⁻ Equation 8

4OH⁻→2H₂O+O₂4e⁻ Equation 9

2H⁺+2e⁻→H₂ Equation 10

Porosity and chemistry of PEO coatings can be modified by adjusting process parameters and changing electrolyte composition. Other elements can be included in coatings by addition of nanoparticles and/or microparticles to the electrolyte solution. PEO coatings have inherently high corrosion resistance, wear resistance, and mechanical properties.

1.3.4 PEO System

The PEO process is conducted in an electrolyte bath typically cooled with a heat exchanger or chiller 130 and continuously mixed with an impeller or mixer 128. The substrate 118 is connected to the anode 114 and submerged at a fixed distance from a cathode 112. As power is applied, particles in the electrolyte are encapsulated by the metal oxide layer growing on the metal substrate.

The PEO coatings typically form in three distinct layers: inner and intermediate layers form first, and adhere well to the substrate, with the outer layer forming last and exhibiting a more porous structure. The inherent porosity of these layers allows space for micro-arcs to encapsulate catalyst nanoparticles into the structure. Increasing porosity of coatings will also increase contact surface area, which is desirable for reaction kinetics. The metal oxide coated electrocatalyst can be created or produced using the PEO system and then placed in a PEM system to act as an electrocatalyst.

The metal-oxide coated electrocatalyst system can be manipulated to optimize frequency, voltage, current, and duty cycle from the power supply and control porosity. Frequency can be reduced to decrease voltage interruptions per unit time, thus increasing density of micro arcs on the substrate surface and increasing porosity. Aside from optimal frequency, porosity as a function of voltage and other PEO variables are important. These different types of variable manipulation allow the metal-oxide electrocatalyst system to control bridging between substrate mesh openings and optimize porosity, thereby allowing for high contact surface area with embedded catalyst nanoparticles. Below is a summarized list of variables that can be adjusted to manipulate electrocatalyst growth.
Voltage (affects thickness of growth as well as % crystallinity and crystalline phases)
Current (affects thickness of growth as well as % crystallinity and crystalline phases)
Frequency (determines porosity of growth; higher frequency=less porosity)
Electrolyte additions (determines chemistry of growth; used to control EC and pH which also affects thickness of growth as well as % crystallinity and crystalline phases)
Nanoparticle additions (determines the chemistry of the growth)
Electroconductivity (EC) of electrolyte (affects the electrical properties of the electrolyte and therefore affects thickness of growth as well as % crystallinity and crystalline phases—desired EC=12.5-13.5)
Nanoparticle Suspension (affects chemistry of growth)
Proper mixing of electrolyte bath (affects chemistry of growth)
pH of electrolyte (affects the electrical properties of the electrolyte and therefore affects thickness of growth as well as % crystallinity and crystalline phases—desired pH=11-13)
Temperature of electrolyte (can affect porosity)
Process time (determines thickness of growth)
Cathode-anode distance (can affect growth thickness and crystalline phases)

### 2. Preliminary Testing and Results

Preliminary testing was preformed and confirmed the concept of PEO produced catalysts. Several variations of the prototype were produced and analytical testing performed. The preliminary prototypes were produced in a 15 L electrolyte bath. Both the cathode and anode rods were made from commercially pure titanium (cp-Ti). The substrate used in these initial experiments was cp-Ti screens that measured 1″ in diameter and US mesh size 35. The Ti mesh samples were cleaned in an ultrasonic bath for 15 minutes prior to each test. This phase of PEO testing varied voltage between 300-400 V and residence time between 30-75 minutes. Frequency was held at 200 Hz for this phase of testing. After each set of PEO experiments completed, the resulting sample was rinsed thoroughly with DI water and set aside to dry at room temperature. The measurable for variation of the voltage and time parameters was coating consistency.

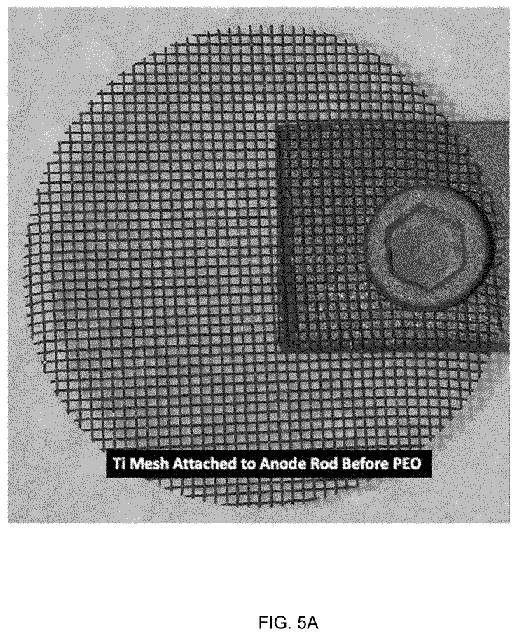

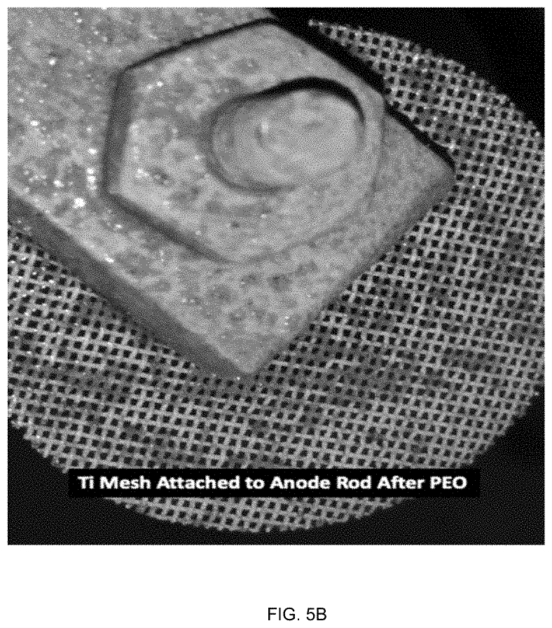

Graphite, copper, zinc, and nickel were added to the electrolyte solution to observe effects on growth of the support and catalyst. Graphite particles with size distribution 400-1200 nm were added to the electrolyte bath at a concentration of 8.6 g/L. Copper, nickel, and zinc particles with size distribution <44 μm were added at concentrations of 12 g/L, 4 g/L, and 4 g/L respectively. The Cu, Ni, and Zn were used as less expensive placeholders for other transition metals with more effective catalytic properties. Also, the particle sizes of Cu, Ni, and Zn were far greater than optimal to observe the effectiveness of stirring on large particle distribution. Results proved to successfully produce PEO grown, TiO2 supported, multi-component electrocatalysts. FIG. 5 is an image of a Ti mesh sample connected to the cp-Ti anode rod before PEO treatment. The image on the right in FIG. 5 shows the mesh sample after the PEO treatment was completed. A comprehensive composition of the electrolyte bath for preliminary tests is found in Table 1.

TABLE 1

| | | |
|---|---|---|
| NaP | 2.71 | g/L |
| Na₂SiO₃ | 3.25 | g/L |
| KOH | 1.63 | g/L |
| Glycerol | 1.08 | g/L |
| Graphite (400-1,200 nm) | 8.6 | g/L |
| Cu (<44 μm) | 12 | g/L |
| Ni (<44 μm) | 4 | g/L |
| Zn (<44 μm) | 4 | g/L |

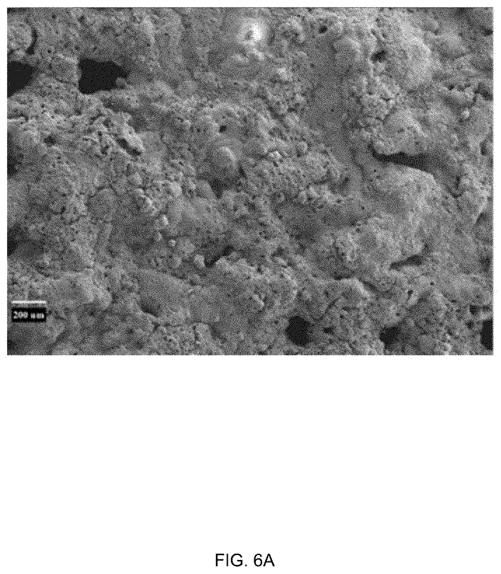

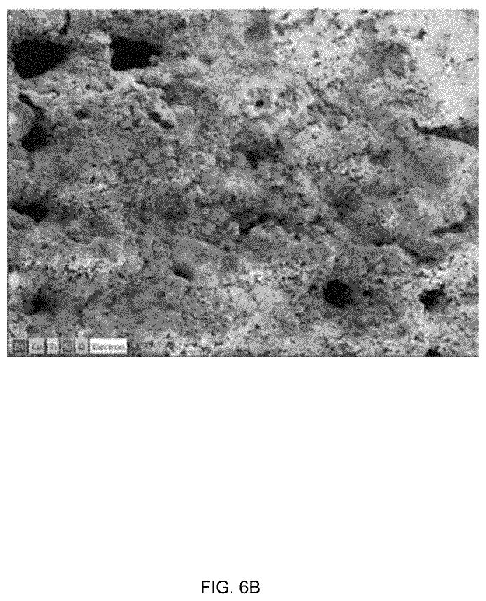

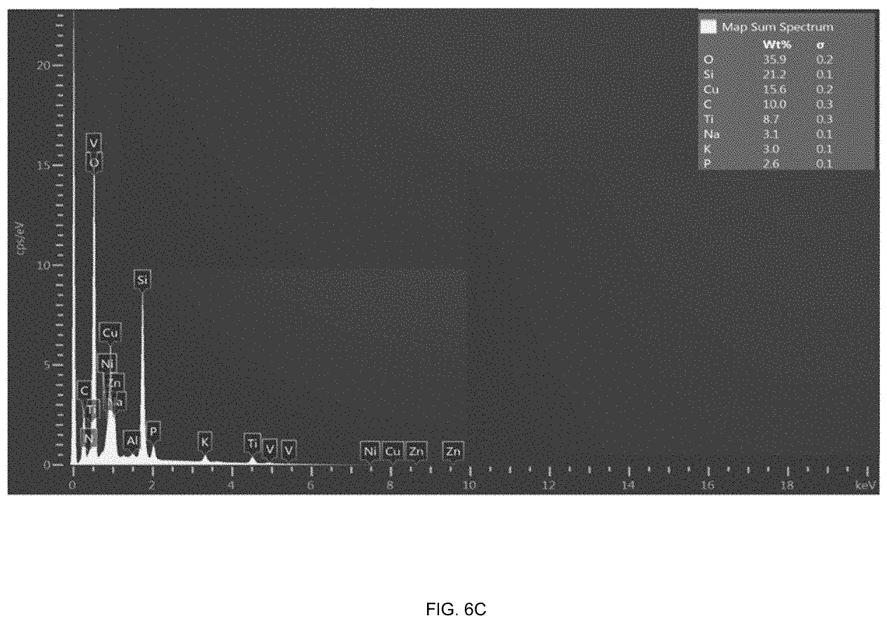

Testing performed on the Ti mesh samples highlighted a window of PEO parameters that creates a TiO2 supported electrocatalyst that successfully encapsulated C, Cu, Ni, and Zn particles. FIG. 6 is SEM/EDS analysis of a sample that was PEO treated at 400 V for 75 min. EDS analysis shows the coating surface is 15.6% Cu and 10.0% C. Na, K, P, and Si were from electrolyte salts. Ti and O is explained by the TiO2 and other oxides. There were also small amounts of Zn and Ni found on the sample surface but are not shown on the map sum spectrum. To increase the concentration of transition metals and carbon in the support, significantly smaller particle sizes may be used and effective surfactants and dispersants may be incorporated into the electrolyte bath.

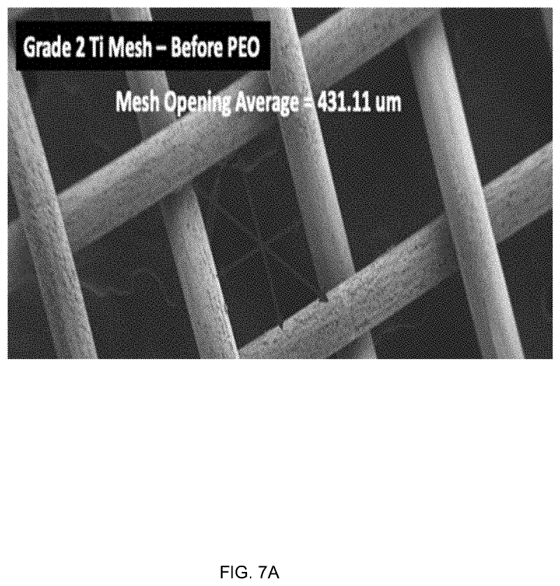

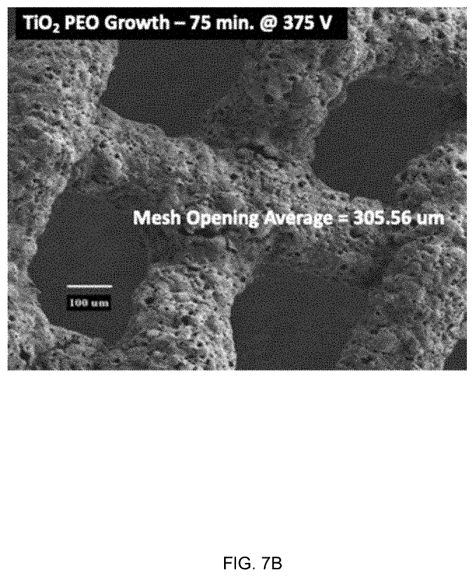

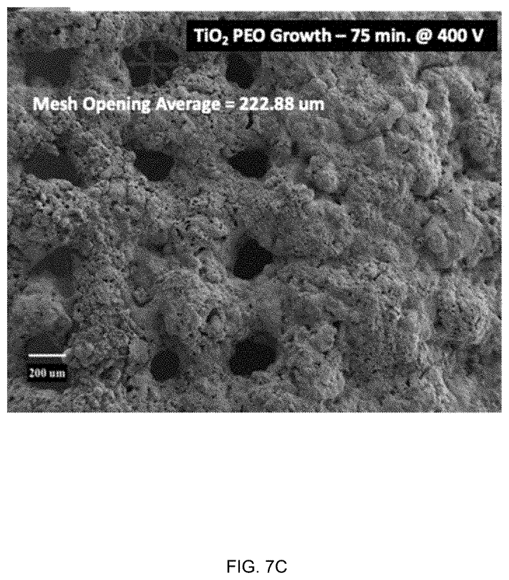

FIG. 7 shows the progressive growth of composite layers from 375 V to 400 V. The image to the left shows the uncoated Ti mesh has an average opening of 431.11 μm. The image in the middle shows the average mesh opening decreases to 305.56 μm after PEO treatment at 375 V for 75 min. The image on the right shows the average mesh opening decreases to 222.88 μm after PEO treatment at 400 V for 75 min. The image on the right of FIG. 7 also shows areas of Ti mesh that were fully bridged with composite coating after completion of PEO at 400 V for 75 min. These images illustrate that porous layer thickness can be controlled to produce open mesh or fully bridged electrocatalysts that still have the benefit of through-porosity.

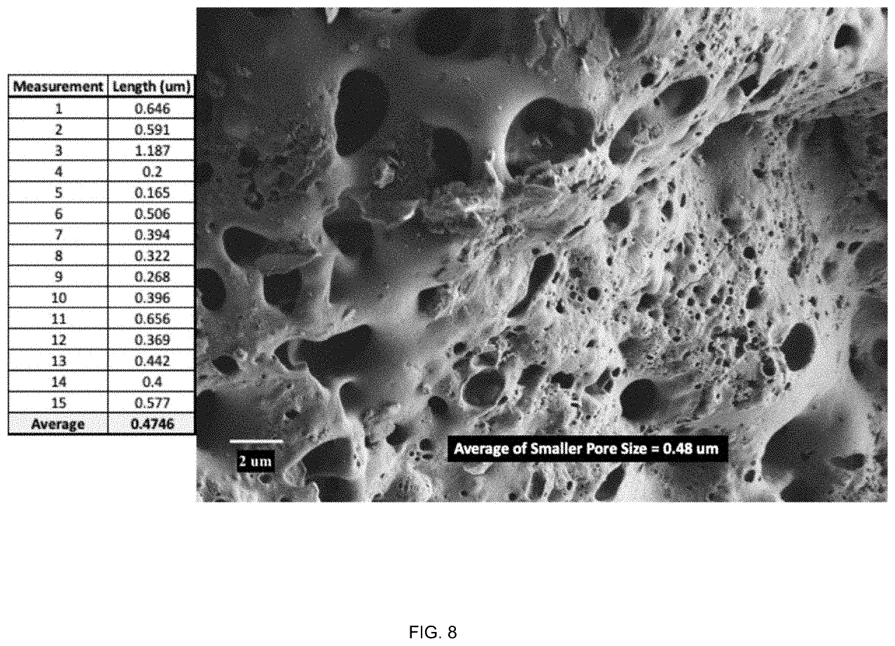

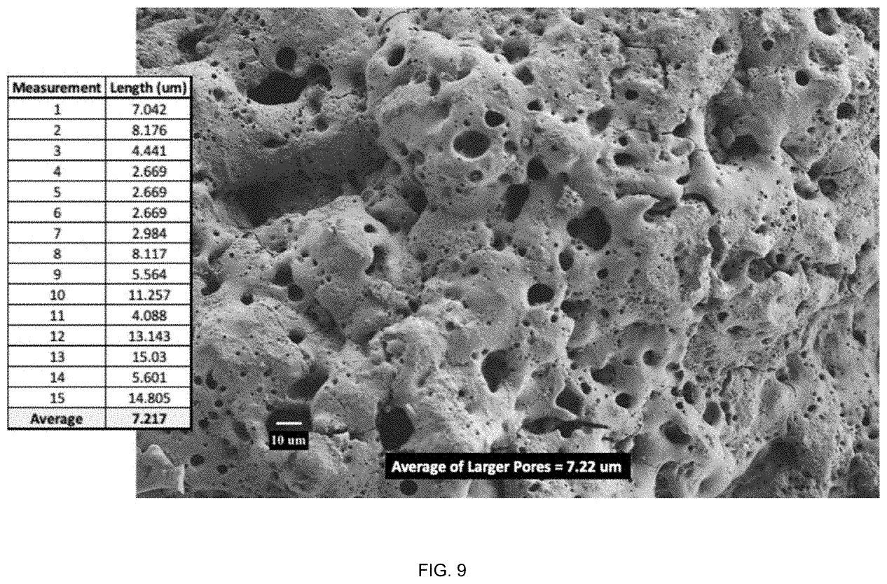

Pore size is another important characteristic of this process. Pore size analysis was performed on selected samples to determine pore size distribution. FIG. 8 and FIG. 9 show pore size analysis results from sample MOC-9, which was treated at 375 V for 75 min. FIG. 8 and FIG. 9 also show a bimodal pore distribution of 0.48 μm smaller pores and 7.22 μm larger pores.

The features, steps, and components of the illustrative aspects may be combined in any number of ways and are not limited specifically to those described. In particular, the illustrative aspects contemplate numerous variations in the metal-oxide electrocatalyst production process and system described. The foregoing description has been presented for purposes of illustration and description. It is not intended to be an exhaustive list or limit any of the disclosure to the precise forms disclosed. It is contemplated that other alternatives or exemplary aspects are considered included in the disclosure. The description is merely examples of aspects, processes or methods of the disclosure. It is understood that any other modifications, substitutions, and/or additions may be made, which are within the intended spirit and scope of the disclosure. For the foregoing, it can be seen that the disclosure accomplishes at least all of the intended objectives.

The previous detailed description is of a small number of aspects for implementing the disclosure and is not intended to be limiting in scope. The following claims set forth a number of the aspects of the disclosure with greater particularity.

What is claimed is:

1. A metal-oxide electrocatalyst producing system for creating a metal substrate, the system comprising:
a tank housing an electrolyte bath, wherein the electrolyte bath comprises a plurality of metal ions;
a power supply operatively connected to the electrolyte bath, the power supply comprising a positive connection and a negative connection;
an anode connected to the positive connection and a metal substrate, wherein the anode supplies an anode voltage from the power supply to the metal substrate when the metal substrate is submerged in the electrolyte bath; and
a cathode connected to the negative connection and partially submerged in the electrolyte bath;
wherein the electrolyte bath produces a functional material layer that forms on a surface of the metal substrate.

2. The metal-oxide electrocatalyst producing system of claim 1, further comprising a chiller for supplying cooled electrolytes to the electrolyte bath.

3. The metal-oxide electrocatalyst producing system of claim 1, wherein the system comprises a plasma electrolytic oxidation (PEO) process.

4. The metal-oxide electrocatalyst producing system of claim 1, wherein the cathode and the anode completes a voltage circuit.

5. The metal-oxide electrocatalyst producing system of claim 1, wherein the system comprises a proton exchange membrane (PEM) process.

6. A plasma electrolytic oxidation system for producing metal-oxide electrocatalysts on a substrate, the system comprising:
a tank housing an electrolyte bath, wherein the electrolyte bath comprises a plurality of nanoparticles;
a power supply operatively connected to the electrolyte bath, the power supply comprising a positive connection and a negative connection;
an anode connected to the positive connection and a substrate, wherein the anode conducts a high voltage received from the power supply to the substrate when the substrate is submerged in the electrolyte bath; and
a cathode connected to the negative connection and partially submerged in the electrolyte bath;
wherein a metal-oxide functional layer forms on a surface of the substrate.

7. The plasma electrolytic oxidation system of claim 6, wherein the metal-oxide functional layer comprises an inner layer, an intermediate layer, and an outer layer, and wherein the inner layer and the intermediate layer adhere to the surface of the substrate and the outer layer has a porous topography.

8. The plasma electrolytic oxidation system of claim 6, wherein the nanoparticles in the electrolyte are encapsulated by the metal oxide layer forming on the metal substrate for producing an electrocatalyst.

9. The plasma electrolytic oxidation system of claim 6, wherein the plurality of nanoparticles comprise at least one metal from the set of graphite, copper, zinc, and nickel.

10. The plasma electrolytic oxidation system of claim 6, wherein the electrolyte bath comprises a least one electrolyte additions from the set of KOH, Na₃PO₄, Na₂SiO₃, NaOH, NaAlO₂, and K₄P₂O₇.

11. A method for producing metal-oxide electrocatalysts, the method comprising:
providing an electrolyte bath housed in a tank, wherein the electrolyte bath comprises at least one metal ion and an alkaline solution;
connecting a cathode to a power supply and partially submerging the cathode in the electrolyte bath;
connecting an anode to a power supply and a metal substrate;
supplying a voltage to the anode from the power supply to the metal substrate, wherein the cathode completes the electrical circuit when the metal substrate is submerged in the electrolyte bath;
forming a metal-oxide layer on a surface of the metal substrate when the metal substrate is submerged in the electrolyte bath for transforming the metal substrate into a metal-oxide coated electrocatalyst and wherein the metal-oxide layer comprises the at least one metal ion; and
removing the metal-oxide electrocatalyst from the electrolyte bath.

12. The method of claim 11, wherein the electrolyte bath further comprises carbon nanoparticles.

13. The method of claim 11, wherein the electrolyte bath comprises a pH from 11-13 and a electroconductivity from 12.5-13.5 to optimize the growth of the metal oxide layer.

14. The method of claim 11, wherein the electrolyte bath comprises at least one of a set of surfactants and dispersants.

15. A metal oxide coated electrocatalyst coated material, comprising:
a substrate; and
an electrocatalyst that forms on a surface of the substrate;
wherein the substrate is submerged in an electrolyte bath transforming the substrate into a electrocatalyst and wherein an oxide layer comprises at least one nanoparticle from the electrolyte bath; and
wherein an anode connected to a positive electrical connection and the substrate supplies an anode voltage to the substrate when the metal substrate is submerged in the electrolyte bath; and a cathode connected to a negative electrical connection and partially submerged in the electrolyte bath, wherein the anode and the cathode complete a voltage circuit.

16. The metal oxide coated electrocatalyst coated material of claim 15, wherein the nanoparticle comprises at least one metal ion.

17. The metal oxide coated electrocatalyst coated material of claim 15, wherein the at least one nanoparticle is encapsulated by the oxide layer forming on the substrate producing the electrocatalyst.

18. The metal oxide coated electrocatalyst coated material of claim 15, wherein the at least one nanoparticle comprises a transition metal.

19. The metal oxide coated electrocatalyst coated material of claim 15, wherein voltage of the voltage circuit determines a rate of formation of the electrocatalyst.

20. The metal oxide coated electrocatalyst coated material of claim 15, wherein the electrolyte bath has a pH from 11-13 and a electroconductivity from 12.5-13.5 to optimize the formation of the oxide layer.
